(19) United States
(12) Patent Application Publication
(10) Pub. No.: US 2016/0063932 A1
(43) Pub. Date: Mar. 3, 2016

(54) OVERDRIVE METHOD, CIRCUIT, AND DISPLAY DEVICE

(71) Applicant: SHENZHEN CHINA STAR OPTOELECTRONICS TECHNOLOGY CO., LTD., Shenzhen, Guangdong (CN)

(72) Inventors: Jinjie Zhou, Shenzhen (CN); Xiaoping Tan, Shenzhen (CN); Yu Yeh Chen, Shenzhen (CN)

(21) Appl. No.: 14/417,159

(22) PCT Filed: Sep. 16, 2014
(86) PCT No.: PCT/CN2014/086650

§ 371 Date: Jun. 5, 2015

(30) Foreign Application Priority Data
Sep. 2, 2014 (CN) 201410443944.6

(51) Int. Cl. G09G 3/36; H04N 13/04

(52) U.S. Cl. CPC G09G 3/3607; G09G 3/3696; G09G 3/3614; H04N 13/044; H04N 13/0497; G09G 2310/08; G09G 2310/0291; G09G 2310/0297

(57) ABSTRACT

An overdrive method, a circuit, and a display device are disclosed, which belong to the field of display technologies. The technical problem of inconsistent brightness of left-eye pictures and right-eye pictures with respect to each other occurring in the prior art can be eliminated. The overdrive method comprises: acquiring grayscale of a present frame; judging whether the present frame is a left-eye picture or a right-eye picture; and looking up an overdrive grayscale value in a first overdrive table according to the grayscale of the present frame and that of a previous frame, if the present frame is a left-eye picture; or looking up an overdrive grayscale value in a second overdrive table according to the grayscale of the present frame and that of a previous frame, if the present frame is a right-eye picture.

The present application claims benefit of Chinese patent application CN 201410443944.6, entitled “Overdrive method, circuit, and display device” and filed on Sep. 2, 2014, the entirety of which is incorporated herein by reference.

### FIELD OF THE INVENTION

The present disclosure relates to the field of display technologies, and in particular, to an overdrive method, a circuit, and a display device.

### BACKGROUND OF THE INVENTION

A three-dimensional picture can be vividly displayed through 3D display technologies, which enable viewers to see different pictures with their left and right eyes respectively.

An active shutter 3D technology, as one of current mainstream 3D technologies, works as follows. Left-eye and right-eye pictures are alternately displayed by a display device at a refresh rate of 120 Hz or even higher. Meanwhile, the switch of a left-eye lens and that of a right-eye lens of a pair of shutter glasses are alternately turned on, so as to allow the viewer to see left-eye pictures only with the left eye, and right-eye pictures only with the right eye. In this manner, 3D display effects can then be achieved through comprehensive functioning of the viewer's brain.

On the other hand, a reversion drive mode is commonly used in a liquid crystal display. That is, the voltages driving liquid crystals are of positive and negative polarities alternately, with the polarity being reversed once for each frame. However, due to voltage deviation of a common electrode, the brightness during positive polarity drive would be higher (or lower) than that during negative polarity drive. In 3D display, left-eye pictures and right-eye pictures are alternately presented. Since left-eye pictures are all driven under positive (or negative) polarity, and right-eye pictures are all driven under negative (or positive) polarity, the phenomenon of inconsistent brightness of the left-eye pictures and the right-eye pictures with respect to each other would occur, thereby deteriorating 3D display effects.

### SUMMARY OF THE INVENTION

The present disclosure aims to provide an overdrive (OD for short) method, a circuit, and a display device, so as to solve the technical problem of inconsistent brightness of left-eye pictures and right-eye pictures with respect to each other that occurs in the prior art.

The present disclosure provides an overdrive method, comprising:

acquiring grayscale of a present frame; and

judging whether the present frame is a left-eye picture or a right-eye picture; and

looking up an overdrive grayscale value in a first overdrive table according to the grayscale of the present frame and that of a previous frame, if the present frame is a left-eye picture; or

looking up an overdrive grayscale value in a second overdrive table according to the grayscale of the present frame and that of a previous frame, if the present frame is a right-eye picture.

Preferably, judging whether the present frame is a left-eye picture or a right-eye picture specifically comprises: reading out a control signal that is synchronously output with a grayscale signal, and judging whether the present frame is a left-eye picture or a right-eye picture by determining whether the control signal is of a high-level voltage or of a low-level voltage.

The present disclosure further provides an overdrive circuit, comprising a data multiplexer, a buffer, a first look-up table circuit, and a second look-up table circuit, wherein the data multiplexer is used for acquiring grayscale of a present frame, judging whether the present frame is a left-eye picture or a right-eye picture, and outputting the grayscale of the present frame to the first look-up table circuit if the present frame is a left-eye picture, or outputting the grayscale of the present frame to the second look-up table circuit if the present frame is a right-eye picture;

wherein the buffer is used for caching grayscale of a previous frame;

wherein the first look-up table circuit is used for looking up an overdrive grayscale value in a first overdrive table according to the grayscale of the present frame and that of the previous frame; and

wherein the second look-up table circuit is used for looking up an overdrive grayscale value in a second overdrive table according to the grayscale of the present frame and that of the previous frame.

Preferably, the data multiplexer is specifically used for acquiring the grayscale of the present frame, reading out a control signal synchronously output with a grayscale signal, judging whether the present frame is a left-eye picture or a right-eye picture by determining whether the control signal is of a high-level voltage or of a low-level voltage, and outputting the grayscale of the present frame to the first look-up table circuit if the present frame is a left-eye picture, or outputting the grayscale of the present frame to the second look-up table circuit if the present frame is a right-eye picture.

The present disclosure further provides a display device, comprising a display unit and a drive unit which includes an overdrive circuit,

wherein the overdrive circuit comprises a data multiplexer, a buffer, a first look-up table circuit, and a second look-up table circuit,

wherein the data multiplexer is used for acquiring grayscale of a present frame, judging whether the present frame is a left-eye picture or a right-eye picture, and outputting the grayscale of the present frame to the first look-up table circuit if the present frame is a left-eye picture, or outputting the grayscale of the present frame to the second look-up table circuit if the present frame is a right-eye picture;

wherein the buffer is used for caching grayscale of a previous frame;

wherein the first look-up table circuit is used for looking up an overdrive grayscale value in a first overdrive table according to the grayscale of the present frame and that of the previous frame, and outputting the overdrive grayscale value to the display unit; and

wherein the second look-up table circuit is used for looking up an overdrive grayscale value in a second overdrive table according to the grayscale of the present frame and that of the previous frame, and outputting the overdrive grayscale value to the display unit.

Preferably, the drive unit further comprises a timing controller therein, used for outputting a control signal synchronously output with a grayscale signal,

wherein the data multiplexer is specifically used for acquiring the grayscale of the present frame, reading out the control signal, judging whether the present frame is a left-eye picture or a right-eye picture by determining whether the control signal is of a high-level voltage or of a low-level voltage, and outputting the grayscale of the present frame to the first look-up table circuit if the present frame is a left-eye picture, or outputting the grayscale of the present frame to the second look-up table circuit if the present frame is a right-eye picture.

Furthermore, the drive unit comprises a memory therein, used for storing the first overdrive table and the second overdrive table.

The present disclosure can bring about the following beneficial effects. In the overdrive method of the present disclosure, the present frame is first judged to be a left-eye picture or a right-eye picture. Subsequently, different overdrive grayscale values can be looked up in the first overdrive table and the second overdrive table for left-eye pictures and right-eye pictures, respectively, based on corresponding judgment results. As a result, the brightness of left-eye pictures can be consistent with that of right-eye pictures, thereby eliminating the technical problem of inconsistent brightness of left-eye pictures and right-eye pictures with respect to each other in the prior art.

Other features and advantages of the present disclosure will be further explained in the following description, and partly become self-evident therefrom, or be understood through implementing the present disclosure. The objectives and advantages of the present disclosure will be achieved through the structure specifically pointed out in the description, claims, and the accompanying drawings.

### BRIEF DESCRIPTION OF THE DRAWINGS

In order to explicitly illustrate the technical solution of the embodiments of the present disclosure, the embodiments will be described in combination with accompanying drawings, in which:

FIG. 1 shows a flow chart of an overdrive method provided in Embodiment 1 of the present disclosure;

FIG. 2 schematically shows an overdrive circuit provided in Embodiment 1 of the present disclosure; and

FIG. 3 schematically shows a drive unit in a display device provided in Embodiment 2 of the present disclosure.

### DETAILED DESCRIPTION OF THE EMBODIMENTS

The present disclosure will be explained in details with reference to the embodiments and the accompanying drawings, whereby it can be fully understood how to solve the technical problem by the technical means according to the present disclosure and achieve the technical effects thereof, and thus the technical solution according to the present disclosure can be implemented. It is important to note that as long as there is no structural conflict, all the technical features mentioned in all the embodiments may be combined together in any manner, and the technical solutions obtained in this manner all fall within the scope of the present disclosure.

### Embodiment 1

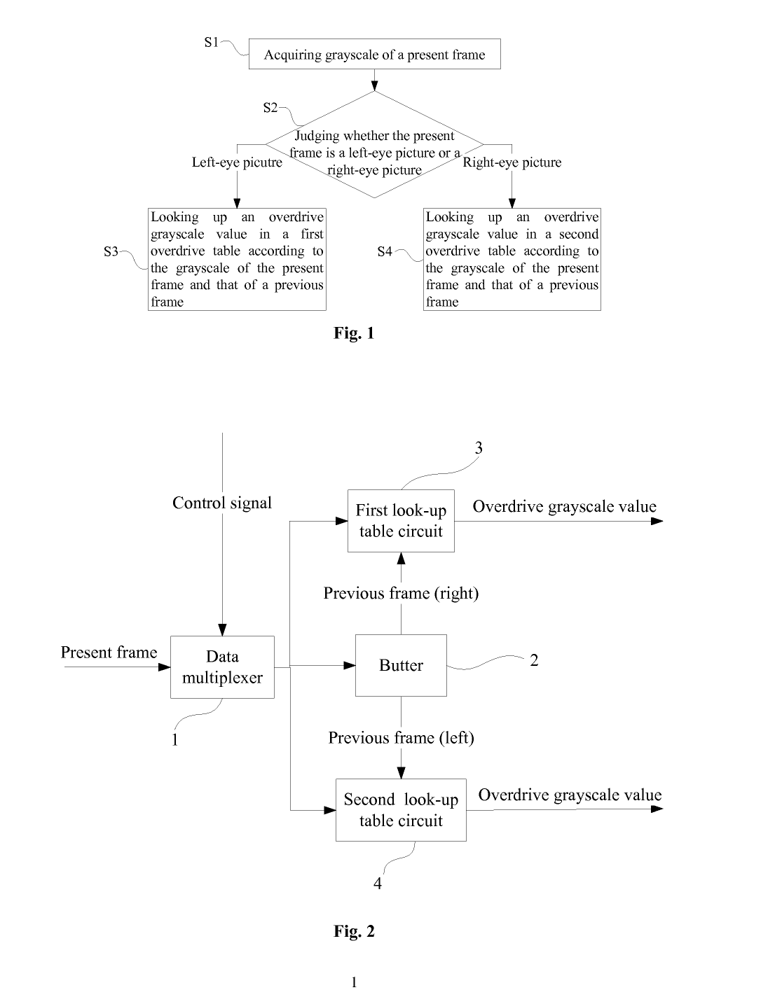

As FIG. 1 shows, in this embodiment of the present disclosure, an overdrive method is provided, which can be used in an active shutter 3D display device. The overdrive method comprises the following steps.

In step S1, grayscale of a present frame, i.e., grayscale of a picture frame to be displayed at present, is acquired.

In step S2, the present frame is judged to be a left-eye picture or a right-eye picture.

In one preferred embodiment, a control signal can be output from a display device synchronously with a grayscale signal. The control signal can either be of a high-level voltage or of a low-level voltage, and has a variation period that matches with a frame period. In this manner, the high-level voltage of the control signal can be synchronously output with left-eye pictures (or right-eye pictures), and the low-level voltage of the control signal can be synchronously output with right-eye pictures (or left-eye pictures).

In this step, the control signal is read out, and the present frame can be judged as a left-eye picture or a right-eye picture by determining whether the control signal is of a high-level voltage or of a low-level voltage.

In step S3, if the present frame is a left-eye picture, an overdrive grayscale value is looked up in a first overdrive table according to the grayscale of the present frame (a left-eye picture) and that of a previous frame (a right-eye picture).

In step S4, if the present frame is a right-eye picture, an overdrive grayscale value is looked up in a second overdrive table according to the grayscale of the present frame (a right-eye picture) and that of a previous frame (a left-eye picture).

Subsequently, the over grayscale value obtained in step S3 or step S4 can be used for 3D display.

As shown in FIG. 2, in the embodiment of the present disclosure, an overdrive circuit is further provided, comprising a data multiplexer (DMUX) 1, a buffer 2, a first look-up table circuit 3, and a second look-up table circuit 4.

The DMUX 1 can be used for acquiring grayscale of a present frame, reading out a control signal synchronously output with a grayscale signal, and judging whether the present frame is a left-eye picture or a right-eye picture by determining whether the control signal is of a high-level voltage or of a low-level voltage. If the present frame is a left-eye picture, the grayscale of the present frame is output to the first look-up table circuit 3, while if the present frame is a right-eye picture, the grayscale of the present frame is output to the second look-up table circuit 4.

The buffer 2 can be used for caching grayscale of a previous frame. During display of the present frame, the grayscale of the present frame can be cached in the buffer 2 as “grayscale of a previous frame” during overdrive of a next frame.

The first look-up table circuit 3 can be used for looking up an overdrive grayscale value in the first overdrive table according to the grayscale of the present frame (a left-eye picture) and that of the previous frame (a right-eye picture). The second look-up table circuit 4 can be used for looking up an overdrive grayscale value in the second overdrive table according to the grayscale of the present frame (a right-eye picture) and that of the previous frame (a left-eye picture). The overdrive grayscale value obtained by the first look-up table circuit 3 or the second look-up table circuit 4 can be used for 3D display.

In the overdrive method and the overdrive circuit according to the embodiment of the present disclosure, the present frame is first judged to be a left-eye picture or a right-eye picture. Subsequently, different overdrive grayscale values can be looked up in the first overdrive table and the second overdrive table according to corresponding judgment results, respectively for left-eye pictures and right-eye pictures.

If the brightness of the left-eye picture is relatively how, the first overdrive table or the second overdrive table can be adjusted, so as to enable the overdrive grayscale value of the left-eye picture to be larger than the overdrive grayscale value of the right-eye picture. If the brightness of the right-eye picture is relatively low, a similar step can be performed, so as to enable the overdrive grayscale value of the right-eye picture to be larger than the overdrive grayscale value of the left-eye picture. In this manner, the brightness of the left-eye picture and that of the right-eye picture can be consistent with each other. As a result, the technical problem of inconsistent brightness of the left-eye picture and the right-eye picture with respect to each other can be eliminated, thereby improving 3D display effects.

### Embodiment 2

In this embodiment of the present disclosure, a display device is provided, which can specifically be a liquid crystal display, a liquid crystal television, and the like having the function of 3D display. The display device comprises a drive unit and a display unit (a liquid crystal module).

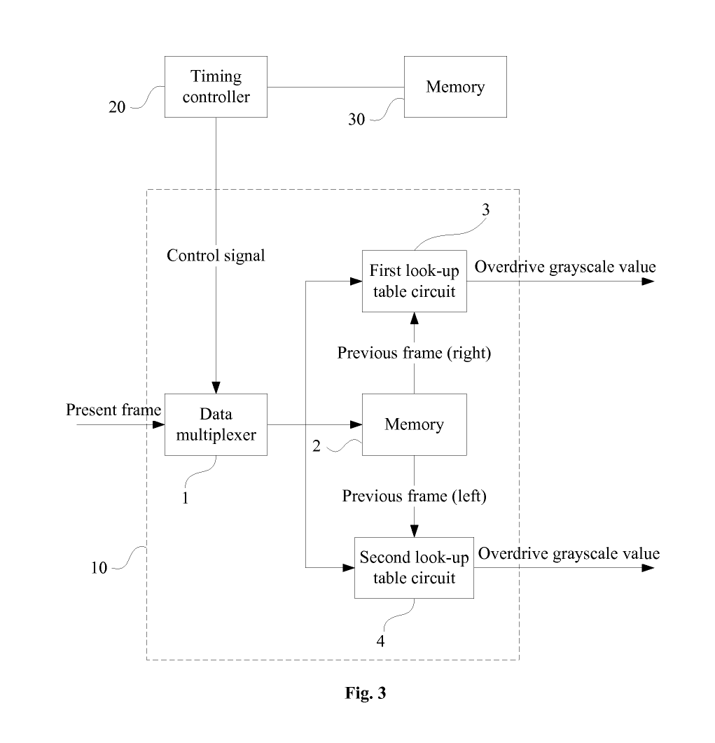

As FIG. 3 illustrates, the drive unit comprises an overdrive circuit 10 and a timing controller (TCON for short) 20 therein. The overdrive circuit 10 includes a data multiplexer 1, a buffer 2, a first look-up table circuit 3, and a second look-up table circuit 4.

The timing controller 20 can be used for outputting a control signal synchronously with a grayscale signal. The control signal can either be of a high-level voltage or of a low-level voltage, and has a variation period that matches with a frame period. In this manner, the high-level voltage of the control signal can be synchronously output with left-eye pictures (or right-eye pictures), and the low-level voltage of the control signal can be synchronously output with right-eye pictures (or left-eye pictures).

The DMUX 1 can be used for acquiring grayscale of a present frame, reading out the control signal output from the timing controller 20, and judging whether the present frame is a left-eye picture or a right-eye picture by determining whether the control signal is of a high-level voltage or of a low-level voltage. If the present frame is a left-eye picture, the grayscale of the present frame is output to the first look-up table circuit 3, while if the present frame is a right-eye picture, the grayscale of the present frame is output to the second look-up table circuit 4.

The buffer 2 can be used for caching grayscale of a previous frame. During display of the present frame, the grayscale of the present frame can be cached in the buffer 2 as “grayscale of a previous frame” during overdrive of a next frame.

The first look-up table circuit 3 can be used for looking up an overdrive grayscale value in the first overdrive table according to the grayscale of the present frame (a left-eye picture) and that of the previous frame (a right-eye picture). The second look-up table circuit 4 can be used for looking up an overdrive grayscale value in the second overdrive table according to the grayscale of the present frame (a right-eye picture) and that of the previous frame (a left-eye picture). The overdrive grayscale value obtained by the first look-up table circuit 3 or the second look-up table circuit 4 can then be input into the display unit, so as to achieve 3D display.

Furthermore, in the present embodiment, the drive unit further comprises a memory 30 therein, which can be connected to the timing controller 20, for storing the first overdrive table and the second overdrive table. In other embodiments, the memory can also be directly connected to the first look-up table circuit and the second look-up table circuit.

The display device of Embodiment 2 shares the same technical features as the overdrive method and the overdrive circuit of Embodiment 1, and therefore can solve the same technical problems and arrive at the same technical effects.

While the embodiments of the present disclosure are described above, the description should not be construed as limitations of the present disclosure, but merely as embodiments for readily understanding the present disclosure. Anyone skilled in the art, within the spirit and scope of the present disclosure, can make amendments or modification to the implementing forms and details of the embodiments. Hence, the scope of the present disclosure should be subject to the scope defined in the claims.

1. An overdrive method, comprising:
acquiring grayscale of a present frame;
judging whether the present frame is a left-eye picture or a right-eye picture; and
looking up an overdrive grayscale value in a first overdrive table according to the grayscale of the present frame and that of a previous frame, if the present frame is a left-eye picture; or
looking up an overdrive grayscale value in a second overdrive table according to the grayscale of the present frame and that of a previous frame, if the present frame is a right-eye picture.

2. The overdrive method according to claim 1, wherein judging whether the present frame is a left-eye picture or a right-eye picture specifically comprises:
reading out a control signal that is synchronously output with a grayscale signal, and judging whether the present frame is a left-eye picture or a right-eye picture by determining whether the control signal is of a high-level voltage or of a low-level voltage.

3. An overdrive circuit, comprising a data multiplexer, a buffer, a first look-up table circuit, and a second look-up table circuit,
wherein the data multiplexer is used for acquiring grayscale of a present frame, judging whether the present frame is a left-eye picture or a right-eye picture, and outputting the grayscale of the present frame to the first look-up table circuit if the present frame is a left-eye picture, or outputting the grayscale of the present frame to the second look-up table circuit if the present frame is a right-eye picture;
wherein the buffer is used for caching grayscale of a previous frame;
wherein the first look-up table circuit is used for looking up an overdrive grayscale value in a first overdrive table according to the grayscale of the present frame and that of the previous frame; and
wherein the second look-up table circuit is used for looking up an overdrive grayscale value in a second overdrive table according to the grayscale of the present frame and that of the previous frame.

4. The overdrive circuit according to claim 3, wherein the data multiplexer is specifically used for acquiring the grayscale of the present frame, reading out a control signal synchronously output with a grayscale signal, judging whether the present frame is a left-eye picture or a right-eye picture by determining whether the control signal is of a high-level voltage or of a low-level voltage, and outputting the grayscale of the present frame to the first look-up table circuit if the present frame is a left-eye picture, or outputting the grayscale of the present frame to the second look-up table circuit if the present frame is a right-eye picture.

5. A display device, comprising a display unit and a drive unit which includes an overdrive circuit,
wherein the overdrive circuit comprises a data multiplexer, a buffer, a first look-up table circuit, and a second look-up table circuit,
wherein the data multiplexer is used for acquiring grayscale of a present frame, judging whether the present frame is a left-eye picture or a right-eye picture, and outputting the grayscale of the present frame to the first look-up table circuit if the present frame is a left-eye picture, or outputting the grayscale of the present frame to the second look-up table circuit if the present frame is a right-eye picture;
wherein the buffer is used for caching grayscale of a previous frame;
wherein the first look-up table circuit is used for looking up an overdrive grayscale value in a first overdrive table according to the grayscale of the present frame and that of the previous frame, and outputting the overdrive grayscale value to the display unit; and
wherein the second look-up table circuit is used for looking up an overdrive grayscale value in a second overdrive table according to the grayscale of the present frame and that of the previous frame, and outputting the overdrive grayscale value to the display unit.

6. The display device according to claim 5, wherein the drive unit further comprises a timing controller therein, used for outputting a control signal synchronously output with a grayscale signal,
wherein the data multiplexer is specifically used for acquiring the grayscale of the present frame, reading out the control signal, judging whether the present frame is a left-eye picture or a right-eye picture by determining whether the control signal is of a high-level voltage or of a low-level voltage, and outputting the grayscale of the present frame to the first look-up table circuit if the present frame is a left-eye picture, or outputting the grayscale of the present frame to the second look-up table circuit if the present frame is a right-eye picture.

7. The display device according to claim 6, wherein the drive unit further comprises a memory therein, used for storing the first overdrive table and the second overdrive table.
